(19) United States
(12) Patent Application Publication
(10) Pub. No.: US 2024/0361422 A1
(43) Pub. Date: Oct. 31, 2024

(54) ASSISTANCE DATA SELECTION

(71) Applicant: QUALCOMM INCORPORATED, San Diego, CA (US)

(72) Inventors: Srinivas YERRAMALLI, San Diego, CA (US); Mukesh KUMAR, Hyderabad (IN); Alexandros MANOLAKOS, Athens (GR)

(21) Appl. No.: 18/684,326

(22) PCT Filed: Sep. 19, 2022
(86) PCT No.: PCT/US2022/043976

§ 371 Date: Feb. 16, 2024

(30) Foreign Application Priority Data
Oct. 29, 2021 (GR) 20210100743

(51) Int. Cl. G01S 5/02; G01S 5/06

(52) U.S. Cl. CPC G01S 5/0236; G01S 5/06

(57) ABSTRACT

An assistance data selection and use method includes: obtaining, at a user equipment, a plurality of assistance data sets each indicating a respective plurality of positioning reference signal resources; selecting, at the user equipment, a desired assistance data set from the plurality of assistance data sets based on positioning performance information; and either: transmitting, from the user equipment, a first positioning reference signal in accordance with the desired assistance data set; or receiving, by the user equipment, a second positioning reference signal in accordance with the desired assistance data set.

### CROSS-REFERENCE TO RELATED APPLICATIONS

This application claims the benefit of Greek Patent Application No. 20210100743, filed Oct. 29, 2021, entitled “ASSISTANCE DATA SELECTION,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment includes: a transceiver; a memory; and a processor, communicatively coupled to the memory and the transceiver, configured to: obtain a plurality of assistance data sets each indicating a respective plurality of positioning reference signal resources; and select a desired assistance data set from the plurality of assistance data sets based on positioning performance information; wherein the processor is: configured to transmit, via the transceiver, a first positioning reference signal in accordance with the desired assistance data set; or configured to receive, via the transceiver, a second positioning reference signal in accordance with the desired assistance data set; or a combination thereof.

An example assistance data selection and use method includes: obtaining, at a user equipment, a plurality of assistance data sets each indicating a respective plurality of positioning reference signal resources; selecting, at the user equipment, a desired assistance data set from the plurality of assistance data sets based on positioning performance information; and either: transmitting, from the user equipment, a first positioning reference signal in accordance with the desired assistance data set; or receiving, by the user equipment, a second positioning reference signal in accordance with the desired assistance data set.

Another example user equipment includes: means for obtaining a plurality of assistance data sets each indicating a respective plurality of positioning reference signal resources; and means for selecting a desired assistance data set from the plurality of assistance data sets based on positioning performance information; and further comprising: means for transmitting a first positioning reference signal in accordance with the desired assistance data set; or means for receiving a second positioning reference signal in accordance with the desired assistance data set; or a combination thereof.

An example non-transitory, processor-readable storage medium includes processor-readable instructions to cause a processor of a user equipment to: obtain a plurality of assistance data sets each indicating a respective plurality of positioning reference signal resources; and select a desired assistance data set from the plurality of assistance data sets based on positioning performance information; wherein the storage medium further comprises: processor-readable instructions to cause the processor to transmit a first positioning reference signal in accordance with the desired assistance data set; or processor-readable instructions to cause the processor to receive a second positioning reference signal in accordance with the desired assistance data set; or a combination thereof.

An example server includes: a transceiver; a memory; and a processor, communicatively coupled to the memory and the transceiver, configured to: receive, via the transceiver from a user equipment, positioning reference signal measurement information for a plurality of assistance data sets each corresponding to a respective plurality of positioning reference signal resources; identify one or more of the plurality of assistance data sets based on the positioning reference signal measurement information and one or more positioning performance criteria; and transmit, via the transceiver, an indication for the one or more of the plurality of assistance data sets to be used for positioning reference signal transfer by the user equipment.

An assistance data indicating method includes: receiving, at a server from a user equipment, positioning reference signal measurement information for a plurality of assistance data sets each corresponding to a respective plurality of positioning reference signal resources; identifying, at the server, one or more of the plurality of assistance data sets based on the positioning reference signal measurement information and one or more positioning performance criteria; and transmitting, from the server, an indication for the one or more of the plurality of assistance data sets to be used for positioning reference signal transfer by the user equipment.

Another example server includes: means for receiving, from a user equipment, positioning reference signal measurement information for a plurality of assistance data sets each corresponding to a respective plurality of positioning reference signal resources; means for identifying one or more of the plurality of assistance data sets based on the positioning reference signal measurement information and one or more positioning performance criteria; and means for transmitting an indication for the one or more of the plurality of assistance data sets to be used for positioning reference signal transfer by the user equipment.

Another example non-transitory, processor-readable storage medium includes processor-readable instructions to cause a processor of a server to: receive, from a user equipment, positioning reference signal measurement information for a plurality of assistance data sets each corresponding to a respective plurality of positioning reference signal resources; identify one or more of the plurality of assistance data sets based on the positioning reference signal measurement information and one or more positioning performance criteria; and transmit, from the server, an indication for the one or more of the plurality of assistance data sets to be used for positioning reference signal transfer by the user equipment.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example server.

FIG. 7 is a block diagram of a hierarchical priority of assistance data for measuring and/or reporting positioning reference signal resources.

FIG. 8 is a signaling and process flow for selecting one or more assistance data sets and determining position information.

FIG. 9 is a timing diagram of positioning reference signal resources of assistance data and ON times of a discontinuous reception pattern.

FIG. 10 is a block flow diagram of an assistance data selection and use method.

FIG. 11 is a block flow diagram of an assistance data indicating method.

### DETAILED DESCRIPTION

Techniques are discussed herein for selecting one or more assistance data sets from available assistance data sets. For example, a user equipment (UE) may receive (e.g., in response to a request) multiple assistance data (AD) sets each identifying a corresponding set of positioning reference signal resources. The UE can select one or more of the received assistance data sets based on one or more parameters. For example, the one or more parameters may include latency, positioning accuracy, measurement gap configurations, measurement gap sharing between communication/data and positioning, quantities of positioning reference signal resources identified in the received AD sets, estimated amounts of times for the UE to measure the positioning reference signals identified in the AD sets, estimated positioning reference signal measurement accuracies corresponding to the AD sets, frequency ranges corresponding to the AD sets, whether interference is present for any of the received AD sets, or a combination of two or more of these parameters. For example, the UE may determine measurement time estimates for each of the AD sets and select one or more of the AD sets based on each of the one or more AD sets having a respective measurement time estimate that is below a threshold amount of time, e.g., based on a latency requirement for determining a position estimate of the UE. If more than one AD set is selected, then the UE may prioritize the AD sets, e.g., based on one or more considerations such as positioning latency and/or positioning accuracy. The UE may select one or more of the AD sets based on the usefulness of the AD set(s) for sidelink signal transfer with one or more other UEs. The UE may select the AD set(s) that best align with discontinuous reception cycle(s) of one or more other UEs. As another example, the UE may provide the measurement time estimates and/or information from which the measurement time estimates may be determined to another entity (e.g., a server such as a location management function), and the other entity may select one or more AD sets and send an indication of the selected AD set(s) to the UE. The other entity may prioritize multiple selected AD sets based on one or more considerations such as positioning latency and/or positioning accuracy. Other configurations, however, may be used.

Items and/or techniques described herein may provide one or more of the following capabilities, as well as other capabilities not mentioned. Latency for determining a position estimate of a UE may be reduced. Accuracy of a position estimate of a UE may be improved. Energy may be conserved performing sidelink positioning signal transfer between UEs. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

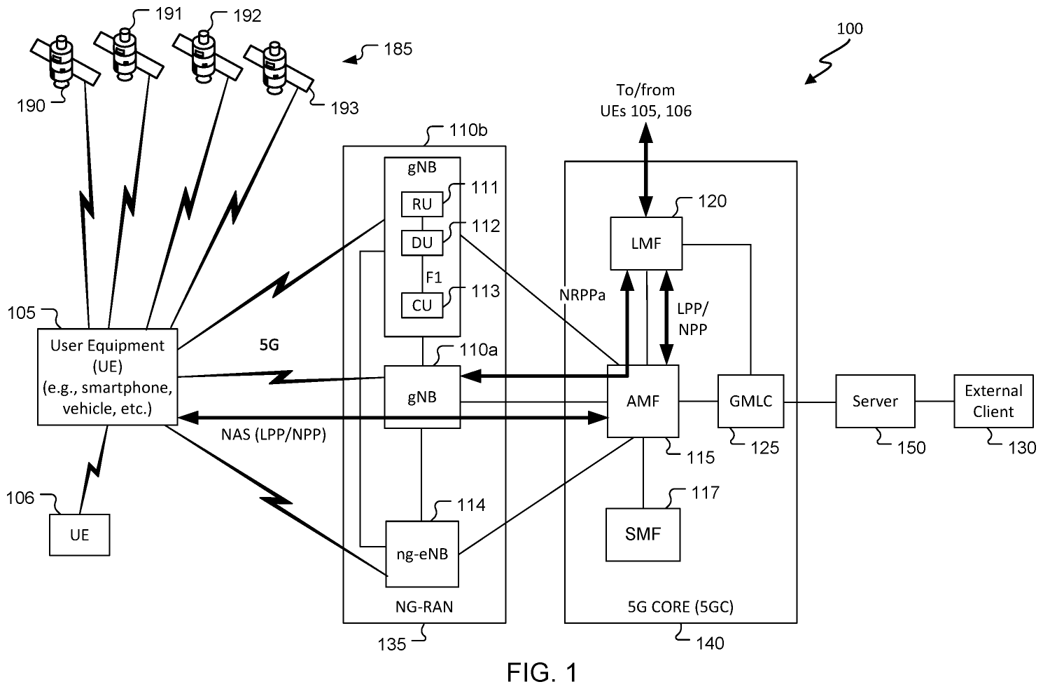

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct device-to-device communications (without going through a network) may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

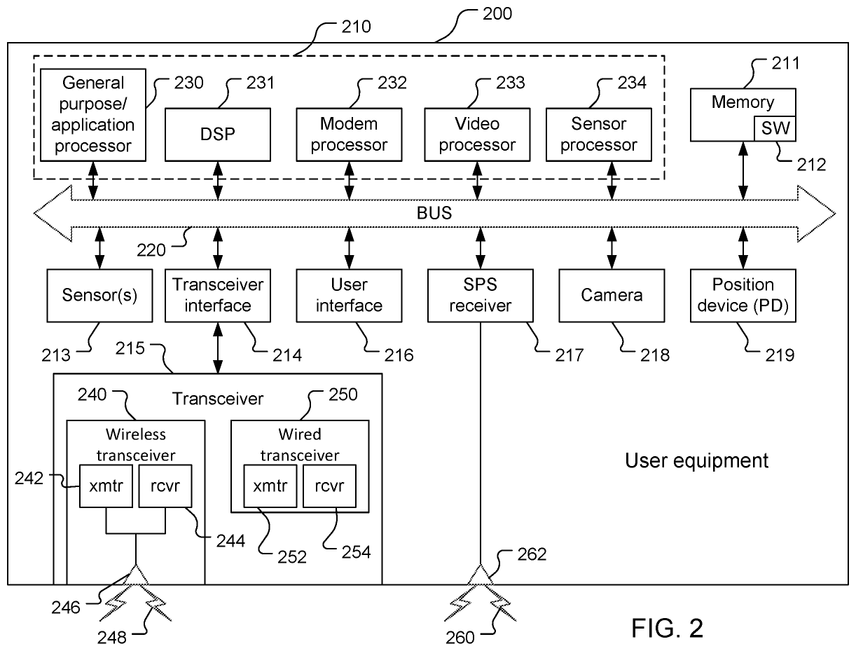

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

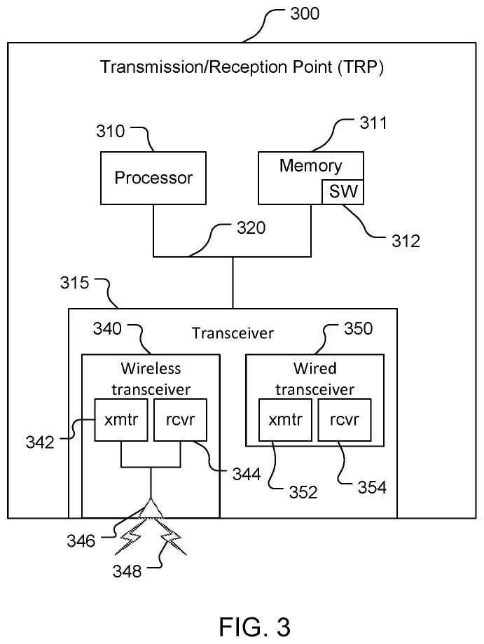

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

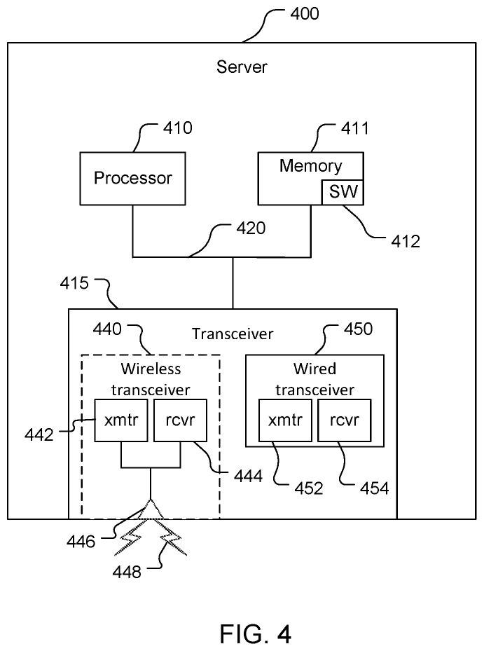

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Assistance Data Selection

A UE may transfer (receive and/or transmit) PRS as part of a positioning technique to determine and/or assist another entity to determine position information (e.g., one or more measurements, ranges, position estimates, etc.). The discussion herein refers to PRS, and the term PRS may refer to DL-PRS, UL-PRS (SRS for positioning), and/or SL-PRS. These signals may also be referred to as NRS (Navigation Reference Signal(s)).

PRS are defined for NR positioning for UEs to detect and measure one or more neighbor entities, e.g., TRPs, UEs. Several configurations of PRS are supported to enable a variety of deployments (e.g., indoor, outdoor, sub-6 GHz, mm-Wave). For example, Table 1 shows various reference signals, the corresponding release of the 3GPP standard, corresponding UE measurement(s), and corresponding positioning technique(s) for which the reference signal(s) may be used.

TABLE 1

| | | Positioning |
|---|---|---|
| DL/UL RS | UE measurement(s) | technique(s) |
| Rel. 16 DL PRS | DL RSTD | DL-TDOA |
| Rel. 16 DL PRS | DL PRS RSRP | DL-TDOA, DL- |
| | | AoD, Multi-RTT |
| Rel. 16 DL PRS/ | UE Rx-Tx | Multi-RTT |
| Rel. 16 SRS for | | |
| positioning | | |
| Rel. 15 SSB/CSI- | SS-RSRP (RSRP | E-CID |
| RS for RRM | for RRM), SS- | |
| | RSRQ (for RRM), | |
| | CSI-RSRP (for | |
| | RRM), CSI-RSRQ | |
| | (for RRM) | |

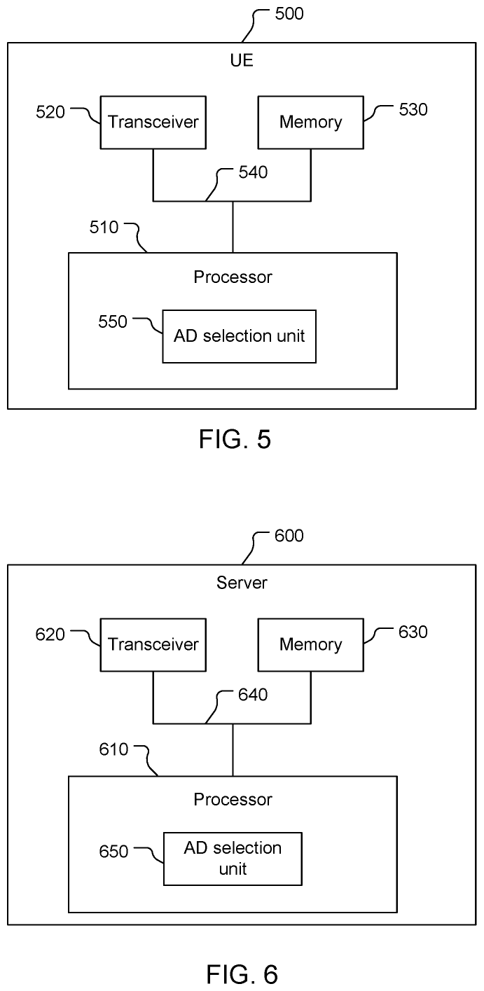

Referring also to FIG. 5, a UE 500 includes a processor 510, a transceiver 520, and a memory 530 communicatively coupled to each other by a bus 540. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include an AD selection unit 550 (assistance data selection unit). The AD selection unit 550 is discussed further below, and the description may refer to the processor 510 generally, or the UE 500 generally, as performing any of the functions of the AD selection unit 550, with the UE 500 being configured to perform the function(s).

Referring also to FIG. 6, a server 600 includes a processor 610, a transceiver 620, and a memory 630 communicatively coupled to each other by a bus 640. The server 600 may include the components shown in FIG. 6. The server 600 may include one or more other components such as any of those shown in FIG. 4 such that the server 400 may be an example of the server 600. For example, the processor 610 may include one or more of the components of the processor 410. The transceiver 620 may include one or more of the components of the transceiver 415. The memory 630 may be configured similarly to the memory 411, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the server 600 performing a function as shorthand for one or more appropriate components (e.g., the processor 610 and the memory 630) of the server 600 performing the function. The processor 610 (possibly in conjunction with the memory 630 and, as appropriate, the transceiver 620) may include an AD selection unit 650. The AD selection unit 650 is discussed further below, and the description may refer to the processor 610 generally, or the server 600 generally, as performing any of the functions of the AD selection unit 650, with the server 600 being configured to perform the function(s).

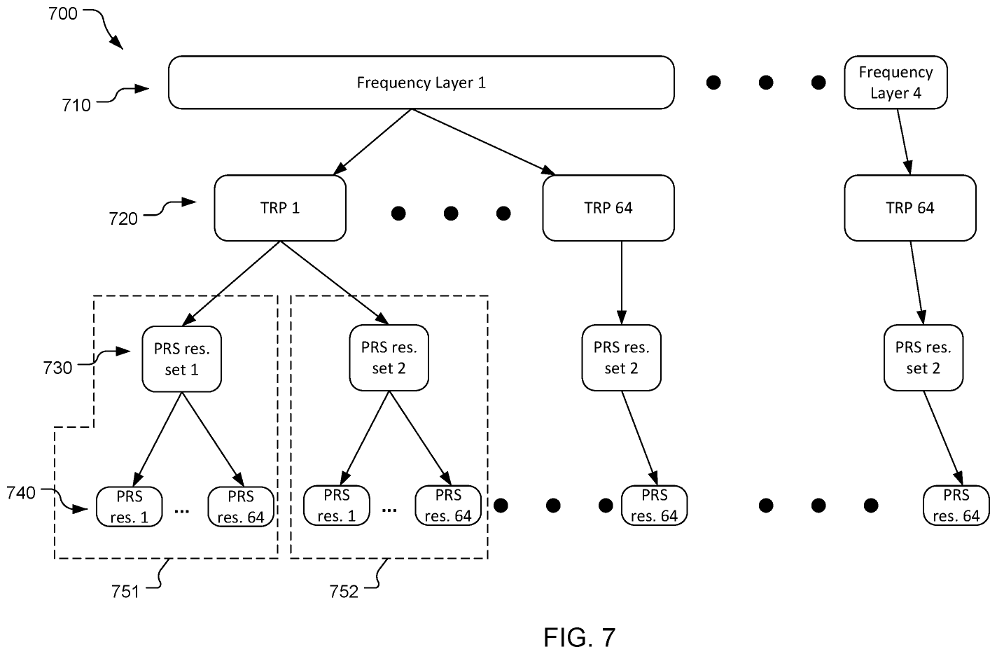

Referring also to FIG. 7, AD 700 (DL-PRS assistance data) from the server 600 indicates frequency layers 710, TRPs 720, PRS resource sets 730, and PRS resources 740 arranged in a hierarchical priority. Within a positioning frequency layer (PFL), the DL-PRS resources are sorted in decreasing order of priority for measurement by the UE 500, with a reference indicated by an nr-DL-PRS-ReferenceInfo information element being the highest priority for measurement. The AD 700 is arranged in order of priority and the frequency layers 710, TRPs 720, PRS resource sets 730, and PRS resources 740 are provided with index numbers for their respective priorities in their respective portions of the priority indicated by the AD 700 (e.g., PRS resources within a PRS resource set). In the priority indicated by the AD 700, the frequency layers 710 have a frequency layer priority such that all the scheduled PRS resources of a frequency layer will be measured before any PRS resource of the next-highest-priority frequency layer. Similarly, the TRPs 720 associated with each of the frequency layers 710 have a TRP priority, the PRS resource sets 730 associated with each TRP priority have a PRS resource set priority, and the PRS resources 740 associated with each PRS resource set have a PRS resource priority. Index numbers may be reused (as shown) for each subset of the priority indicated by the AD 700 (e.g., PRS resources within a PRS resource set, PRS resource sets corresponding to a TRP, etc.). The AD 700 includes full complements of four frequency layers, 64 TRPs in each frequency layer, two PRS resource sets for each TRP, and 64 PRS resources in each PRS resource set, but other quantities of frequency layers, TRPs, PRS resource sets, and/or PRS resources may be used, and quantities may be different (e.g., different quantities of PRS resources in different PRS resource sets). The UE 500 may be configured to report a maximum number of PRS measurements that is lower than the available PRS measurements, or even that the UE 500 measures. Assistance data for sidelink may include PRS resource sets and PRS resources, or PRS resources without PRS resource sets.

The AD 700 may be divided into multiple AD sets. For example, each AD set may correspond to a respective PFL. As another example, a single PFL may be divided into multiple AD sets, e.g., AD sets 751, 752. As another example, a combination of these AD sets may be used, i.e., one or more AD sets that each correspond to a PFL, and one or more PFLs that each include multiple AD sets. As another example, different AD sets may have different repetition factors and/or different time scheduling (e.g., differing system frame numbers). A UE may determine one or more AD sets from AD, e.g., by selecting one or more subsets of the AD as one or more AD sets. For example, if the UE receives AD corresponding to X PRS resources and during an initial search of the X PRS resources is able to find X-Y PRS resources (i.e., a quantity of X minus Y resources), then the UE may track the X-Y PRS resources as a selected AD set.

Historically UEs have supported, and present UEs support, a single PFL each, and an LMF selects AD corresponding to a single PFL for each UE to best match TRP capabilities and UE capabilities (as indicated by the UE), e.g., based on a rough location of the UE (e.g., using E-CID or a serving cell center) and locations of TRPs near the UE and corresponding PFLs of the TRPs. For example, an LMF may select to use TRPs within range of the UE that support, and select the associated AD set for, the single PFL supported by the UE. TRPs may, however, be capable of transmitting PRS using multiple AD sets (e.g., on multiple PFLs). Further, different TRPs may have different AD implementations (e.g., due to different TRP configurations and/or present channel conditions) and/or different AD sets may have different quantities of TRPs. Further, information that may be useful in determining which AD set to use (e.g., that may affect positioning latency and/or accuracy) may not be known by the LMF absent the UE and/or the TRP transmitting the information to the LMF. Consequently, techniques are discussed herein for selecting one or more AD sets in new ways (e.g., based on quantities of PRS resources in AD sets, and/or based on information available to a UE and not available, or not typically available, to a server absent the UE transmitting the information to the server, etc.).

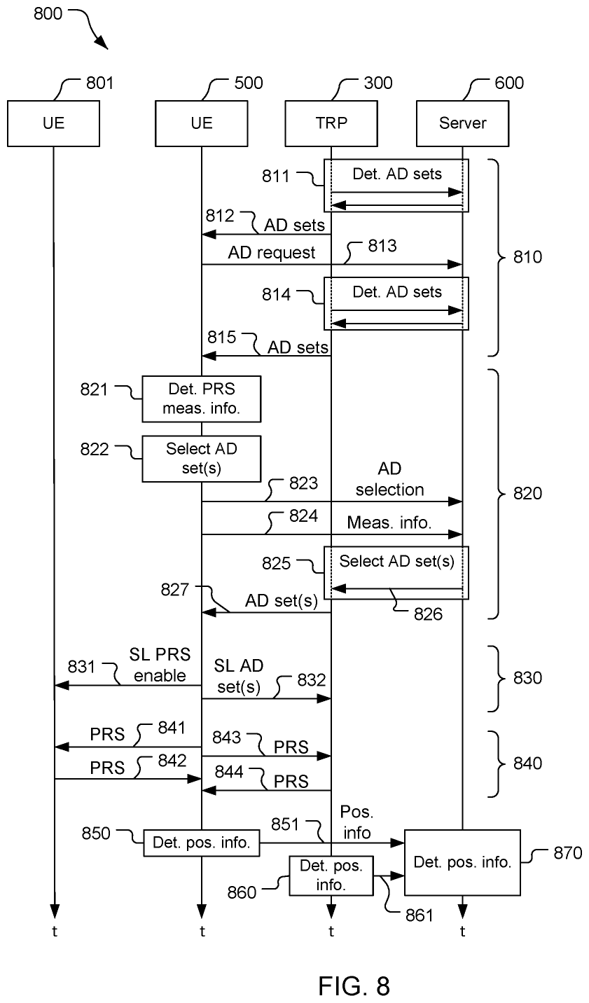

Referring to FIG. 8, with further reference to FIGS. 1-7, a signaling and process flow 800 for selecting one or more assistance data sets from multiple assistance data sets and determining position information based on the selected assistance data set(s) includes the stages shown. Other flows are possible, e.g., with one or more stages shown omitted, one or more stages added, and/or one or more stages shown altered. For example, sub-stage 811 may be omitted or sub-stages 814 may be omitted. As another example, sub-stage 822 or sub-stage 825 may be omitted. As another example, stage 830 may be omitted if sidelink positioning, e.g., between the UE 500 and a UE 801, is not implemented. Still other alterations of the flow 800 may be implemented.

At stage 810, the UE 500 obtains and stores multiple AD sets. For example, at sub-stage 811, the server 600 negotiates with the TRP 300 through bi-directional communication to determine AD sets for the UE 500. The TRP 300 (e.g., a serving gNB for the UE 500) transmits AD sets 812 determined at sub-stage 811 to the UE 500 and the UE 500 receives and stores the AD sets 812 in the memory 530. The AD sets 812 may be sent to the UE 500 independent of, e.g., before initiation of, a positioning session for determining a position estimate for the UE 500. A request to measure PRS may accompany the AD sets 812. Also or alternatively, the UE 500 may transmit an AD request 813 to the server 600 (e.g., via the TRP 300), with the AD request 813 possibly including a capability message indicating one or more capabilities of the UE 500 for processing PRS. The capability message may indicate independent capabilities of the UE 500 to store AD and to process AD. The capability message may indicate the capability of the UE 500 to support multiple AD sets, e.g., to store multiple AD sets and to select one of the AD sets (or to select multiple AD sets if the UE 500 is configured to do so) for use in PRS transfer (reception and/or transmission). The indication of the capability to support multiple AD sets may indicate one or more features of this capability, e.g., that AD sets may span multiple PFLs. At sub-stage 814, the server 600 may respond to receiving the AD request 813 by negotiating with the TRP 300 to determine appropriate AD sets 815 (e.g., based on capabilities of the TRP 300 and the UE 500). The TRP 300 may transmit the AD sets 815 to the UE 500. The server 600 may send a request for the UE 500 to report PRS measurements. The request may be included, for example, with one or more of the AD sets 812, 815. The UE 500 may respond to the request by measuring PRS in accordance with one or more selected AD sets as discussed below.

At stage 820, one or more of the AD sets received at stage 810 are selected for use in measuring PRS by the UE 500. At sub-stage 821, the UE 500, e.g., the AD selection unit 550, determines PRS measurement information. For example, the AD selection unit 550 may determine information affecting positioning performance, e.g., latency and/or positioning accuracy. Such information may correspond, for example, to the AD sets 812, 815, channel status, measurement gap configuration, measurement gap sharing, and/or number of UE receive beams, etc. For example, the AD selection unit 550 may be configured to calculate an estimated measurement time for measuring PRS of each of the AD sets 812, 815. The AD selection unit 550 may be configured to prioritize and/or select one or more of the AD sets 812, 815 based on the measurement times and one or more positioning performance criteria such as one or more latency requirements and/or one or more positioning accuracy requirements. The one or more positioning performance criteria may depend upon a location application, and may be determined internally to the UE 500 and/or received from another entity, e.g., the server 600. The measurement time calculation may vary based on the positioning technique to be implemented, and may depend on one or more factors that are unknown to the server 600 without the UE 500 or the TRP 300 transmitting values of the parameters to the server 600. For example, the AD selection unit 550 may be configured to calculate a measurement time for RSTD positioning, as indicated in the 3GPP Technical Specification 38.133, according to

$${T}_{RSTD , Total} = {\sum }_{i = 1}^{L} {T}_{RSTD , i} + ( L - 1 ) * max ( {T}_{effect , i} ) \qquad ( 1 )$$

$${T}_{RSTD , i} = \qquad ( 2 )$$

$$( {CSSF}_{PRS , i} * {N}_{RxBeam , i} * ⌈ \frac{{N}_{PRS , i}^{slot}}{{N}_{i}^{′}} ⌉ ⌈ \frac{{L}_{{available}_{PRS} , i}}{{N}_{i}} ⌉ * {N}_{sample} - 1 ) * {T}_{effect , i} + {T}_{last}$$

where

$${CSSF}_{PRS , i} * {N}_{RxBeam , i} * ⌈ \frac{{N}_{PRS , i}^{slot}}{{N}_{i}^{′}} ⌉ ⌈ \frac{{L}_{{available}_{PRS} , i}}{{N}_{i}} ⌉ * {N}_{sample}$$

corresponds to the total number of samples to be measured, where a sample corresponds to all the PRS resources within an effective time period T_{effect,i}. The last sample the UE requires is Tₗₐₛₜ=Tᵢ+T_{available_PRS,i}, where Tᵢ corresponds to the reported UE capability related to PRS processing. CSSF_{PRS,i} is a factor that is used to control how each measurement gap (MG) is shared between positioning and mobility (e.g., RRM (Radio Resource Management)) measurements. If the factor is 1, then there is no sharing of the MG (the entire MG is used for positioning measurements). If the factor is 0, then the entire gap is used for mobility measurements. A non-zero value of the factor indicates a percent of the MG used for positioning measurements (e.g., a factor of 0.7 indicates that 70% of the gap is for positioning measurements and 30% of the gap is for mobility measurements). N_{RxBeam} is a receive (Rx) beam sweeping factor that takes the value of 8 for FR2 (24.25 GHz-52.6 GHz) and a value of 1 for FR1 (410 MHz-7.125 GHz). The factors

$$⌈ \frac{{N}_{PRS , i}^{slot}}{{N}_{i}^{′}} ⌉ ⌈ \frac{{L}_{{available}_{PRS} , i}}{{N}_{i}} ⌉$$

consider the PRS processing UE capability with regard to the current PFL configuration. Nₛₐₘₚₗₑ is the number of samples/instances to measure a periodic PRS. T_{effect,i} corresponds to an effective measurement periodicity (which is derived using the MGRP (measurement gap repetition period), T_{PRS,i}, and the reported capability Tᵢ of the UE 500, according to

$${T}_{effect , i} = ⌈ \frac{{T}_{i}}{{T}_{available \_ PRS , i}} ⌉ * {T}_{available \_ PRS , i} \qquad ( 3 )$$

$$where$$

$${T}_{available \_ PRS , i} = LCM ( {T}_{PRS , i} , {MGRP}_{i} ) \qquad ( 4 )$$

which considers the alignment of the MG periodicity and the PRS periodicity. Tₗₐₛₜ is the measurement duration for the last PRS RSTD sample, including the sampling time and processing time such that

$${T}_{last} = {T}_{i} + {T}_{available \_ PRS , i} \qquad ( 5 )$$

Also or alternatively, other information affecting latency and/or positioning accuracy requirements may be determined. For example, measurement times for positioning techniques other than RSTD may be determined. As another example, PRS measurement accuracies may be estimated for one or more positioning techniques.

The UE 500 may have access to values of one or more factors for determining the information affecting latency and/or positioning accuracy that the server 600 does not. For example, the TRP 300 provides measurement gap configurations and measurement gap sharing policy (e.g., CSSF (Carrier-Specific Scaling Factor)) to the UE 500, e.g., along with the AD sets 812, 815 or in one or more separate messages. As another example, the UE 500 can determine the number of receive beams (N_{RxBeam}) available for PRS measurement. Absent the TRP 300 or the UE 500 providing such information to the server 600, the server 600 may not know the measurement gap configuration, gap sharing policy, and/or number of receive beams of the UE 500 that are available for PRS measurement (which depends on configuration of the UE 500 and may depend on varying conditions such as receive beam use for mobility measurements).

At sub-stage 822, the AD selection unit 550 may select one or more of available AD sets for the UE 500 to use for PRS transfer (e.g., PRS reception and measurement and/or PRS transmission). The AD selection unit 550 may select one or more of the available AD sets based on the specific positioning use case (e.g., positioning technique and/or one or more positioning performance criteria). The UE 500 may be configured to support a single AD set (e.g., a single PFL) or may be configured to support multiple AD sets (e.g., multiple PFLs) for PRS transfer. If the UE 500 is configured to support a single AD set, then the AD selection unit 550 may select a single AD set of available AD sets (here the AD sets 812, 815 and any AD sets stored in the memory 530 for sidelink PRS transfer) that may be used to satisfy one or more positioning performance criteria. For example, the AD selection unit 550 may select the AD set of the available AD sets that best satisfies the one or more positioning performance criteria if multiple sets of the available AD sets satisfy the one or more positioning performance criteria. If the UE 500 is configured to support multiple AD sets (e.g., to store multiple AD sets, and to process a subset of the AD sets and/or to re-prioritize the AD sets (or the selected subset of the AD sets)), then the AD selection unit 550 may be configured to select up to a supported number, M, of AD sets of the available AD sets that satisfy the one or more positioning performance criteria. The AD selection unit 550 may be configured to select the M AD sets that best meet the one or more positioning performance criteria (e.g., a weighted formula of latency and positioning accuracy). The AD selection unit 550 may be configured to select the AD set of multiple AD sets that does not collide with any other UE activities. The AD selection unit 550 may be configured to prioritize the selected AD sets, e.g., based on how well the associated AD will help meet the one or more performance criteria (e.g., based on estimated measurement times and/or estimated signal measurement accuracies associated with the AD sets).

The AD selection unit 550 may be configured to implement machine learning (e.g., a neural network) based on positioning performance information and positioning performance criteria to improve AD set selection over time. For example, the AD selection unit 550 may select one or more AD sets based on selected positioning performance information and determine positioning performance (e.g., based on one or more positioning performance criteria such as latency and/or positioning accuracy and/or power consumption) corresponding to the selected positioning performance information. The AD selection unit 550 may adjust the selection of the positioning performance information based on the resulting positioning performance.

The AD selection unit 550 may evaluate a variety of positioning performance information in order to select the AD set(s) to support for PRS transfer, e.g., to meet one or more positioning performance criteria (e.g., desired latency and/or positioning accuracy). For example, the AD selection unit 550 may evaluate estimated measurement time, allowed positioning latency, estimated PRS measurement accuracy, allowed PRS measurement accuracy, allowed positioning accuracy, quantity of PRS resources per AD set, quantity of receive beams, measurement gap configuration, measurement gap sharing (e.g., CSSF), AD set frequency (e.g., FR1 vs. FR2), and/or IDC issues (in-device coexistence issues), etc., and may consider a combination of two or more of these considerations. For example, the AD selection unit 550 may determine whether the estimated measurement time associated win an AD set is lower than an acceptable threshold corresponding to a threshold latency for determining a position estimate of the UE 500. As another example, the AD selection unit 550 may determine the AD set (or sets) that best help meet a latency requirement. As another example, the AD selection unit 550 may determine whether the measurement time associated win an AD set is lower than an acceptable threshold corresponding to a threshold accuracy for determining a position estimate of the UE 500, and/or may determine the AD set (or sets) that best help meet the accuracy threshold. As another example, the AD selection unit 550 may determine whether an AD set has at least a threshold number of PRS resources, and/or may select the AD set(s) that has at least the threshold number of PRS resources (and/or that has(have) the highest quantity of PRS resources among the available AD sets). As another example, the AD selection unit 550 may determine whether an AD set corresponds to a desired (e.g., available (e.g., not jammed)) frequency band. As another example, the AD selection unit 550 may determine whether an AD set has an acceptable measurement gap, or the AD set(s) that has(have) the longest measurement gap(s). As another example, the AD selection unit 550 may determine whether an AD set has an acceptable CSSF value, e.g., above a threshold CSSF value, or the AD set(s) that has(have) the highest CSSF value(s). As another example, the AD selection unit 550 may determine whether an AD set is useful in view of IDC issues, e.g., whether a frequency band associated with the AD set can be used for measurements or not (e.g., due to the absence or presence of interference due to operation of the UE 500). As another example, the AD selection unit 550 may determine whether resources are colliding between SIMs (subscriber identity modules) for multi-SIM activity (e.g., positioning session on SIM1 while there is activity on SIM2) and select the AD that is not colliding with the multi-SIM activity. As another example, the AD selection unit 550 may consider whether idle mode paging and a measurement occasion collide. If a PRS occasion collides with other UE activity, e.g., an idle mode paging occasion or an SSB (synchronization signal block), then the AD selection unit 550 will give the other activity priority, e.g., giving the paging occasion and/or the SSB higher priority than the PRS occasion.

Various combinations of the considerations may be used. For example, the AD selection unit 550 may select the AD sets with estimated measurement times below a measurement time threshold and CSSF values above a CSSF threshold. As another example, the AD selection unit 550 may select the AD sets with estimated measurement times below a measurement time threshold and quantities of PRS resources above a PRS resource quantity threshold.

The AD selection unit 550 may be configured to prioritize the stored AD sets and/or the selected AD sets. For example, the AD selection unit 550 may prioritize the AD sets 812, 815 based on one or more of the considerations discussed above. For example, the AD selection unit 550 may prioritize the AD sets 812, 815 based on quantity of PRS resources in each of the AD sets 812, 815, or based on quantity of PRS resources in each of the AD sets 812, 815 that have a measurement time below a threshold measurement time. The UE 500 may prioritize the stored AD sets and select the AD set (or multiple AD sets if the UE 500 is configured to support multiple AD sets) based on the priority. For example, the AD selection unit 550 may be configured to select the supported quantity (per the configuration of the UE 500) of one or more AD sets in order of the priority and that does(do) not have any IDC issue preventing measurement using the AD set(s).

The AD selection unit 550 may be configured to select an AD set (or AD sets) for sidelink PRS transfer. The AD selection unit 550 may include SL AD sets in the selection discussed above. The AD selection unit 550 may evaluate one or more additional considerations when selecting the AD set(s) for SL, e.g., whether at least a threshold quantity of other UEs are within SL range and support the AD set(s). One or more SL AD set(s) may be included in the AD sets 812, 815 and/or may be statically stored in the memory 530, e.g., during manufacture of the UE 500.

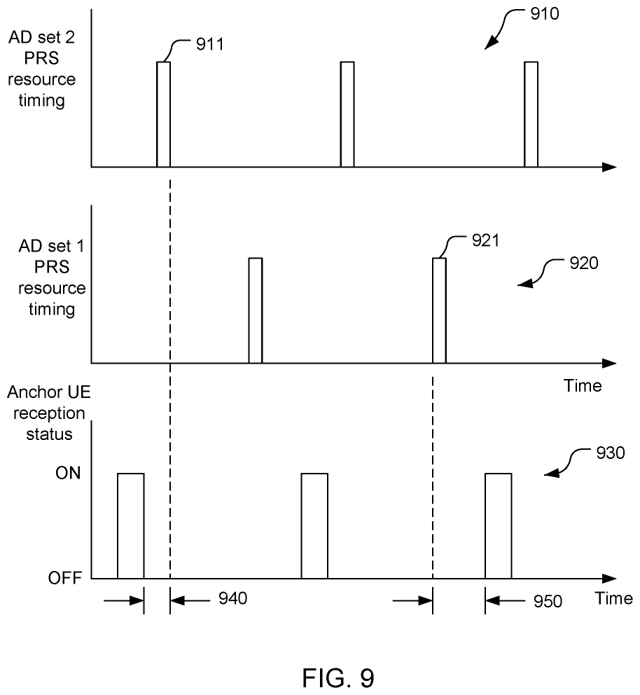

Referring also to FIG. 9, which shows plots 910, 920 of AD PRS timing and a plot 930 of anchor UE DRX timing, the AD selection unit 550 may consider timing of SL AD sets and a discontinuous reception (DRX) pattern (if any) of each anchor UE to select one or more SL AD sets. The AD selection unit 550 may select an SL AD set for PRS transfer with an anchor UE such that the PRS resources of the SL AD set are close to ON times of the anchor UE in the DRX pattern of the anchor UE. For example, the AD selection unit 550 may select an AD set that can be measured within a threshold amount of time of a DRX ON time, e.g., may select AD set 2 if a time 940 is below a threshold amount of time, with the time 940 being an extra amount of time for the anchor UE to be ON in order to measure one or more PRS resources 911 of the AD set 2. As another example, the AD selection unit 550 may select the AD set 2 and an AD set 1 if the time 940 and a time 950 (representing an extra amount of time to be ON to measure one or more PRS resources 921 from AD set 1) are below the threshold time. The AD selection unit 550 may prioritize the AD sets if multiple AD sets are selected, e.g., prioritizing the AD sets in order of lowest to highest extra time for the anchor UE to remain ON to measure respective PRS resource(s) from the AD sets. This may help reduce latency and/or power consumption, e.g., by avoiding increasing ON times of the anchor UE for measuring the PRS. The AD selection unit 550 may select one or more AD sets based on whether the AD set is for UL, DL, or SL signal transfer (e.g., Uu signal transfer between the UE 500 and the TRP 300). For example, if there are few UEs near the UE 500 (e.g., below a threshold quantity of UEs corresponding to a threshold positioning accuracy), then the AD selection unit 550 may select to use Uu PRS transfer, and thus select one or more Uu AD sets, or at least not select any SL AD sets.

The AD selection unit 550 may transmit an AD selection message 823 to the server 600. For example, if the UE 500 is configured to support a single AD set, then the AD selection message 823 may indicate a single selected AD set. Alternatively, the AD selection message 823 may indicate a prioritized order of multiple AD sets from which the server 600 may select a single AD set, e.g., the highest-priority AD set that meets one or more criteria.

The AD selection unit 550 may transmit a measurement information message 824 indicating information from which the server 600, e.g., the AD selection unit 650, may select one or more AD sets as appropriate (e.g., with a selected AD set quantity based on the quantity of AD sets that the UE 500 is configured to support). For example, the measurement information message 824 may include estimated measurement times (e.g., calculated in accordance with Equations (1)-(5)) for the AD sets 812, 815, and/or SL AD set(s), or estimated measurement accuracies for the AD sets 812, 815, and/or SL AD set(s). The measurement information message 824 may include information that the server 600 would not typically have absent receiving the measurement information message 824, e.g., number of receive beams of the UE 500, measurement gap configuration(s), CSSF(s), etc. For example, the measurement information message 824 may be an RRC communication including IDC issue information such as a UEAssistanceInformation information element, e.g., indicating available frequencies (e.g., component carriers) and/or bandwidths, or indicating one or more frequencies and/or frequency combinations that are presently unavailable at the UE 500 (e.g., due to self-interference from one or more components of the transceiver 520). The measurement information message 824 may indicate a quantity of AD sets that the UE 500 supports.

At sub-stage 825, the server 600, e.g., the AD selection unit 650, may select one or more AD sets. The server 600 may select one or more AD sets based on one or more of various considerations, e.g., as discussed with respect to sub-stage 822. Also or alternatively, the AD selection unit 650 may consider one or more factors such as one or more AD sets supported by the UE 500 and by one or more other TRPs within range of the UE 500, a quantity of such other one or more TRPs, an effect on positioning accuracy of the other TRP(s), etc. The server 600 transmits a selected AD set(s) message 826 to the TRP 300 that is an indication to activate the one or more selected AD sets to be used for PRS transfer by the UE 500. The selected AD set(s) message 826 may provide the selected AD set(s) and/or may provide one or more indications of one or more AD sets previously provided to the UE 500 (e.g., the AD sets 812, 815). The selected AD set(s) message 826 may indicate different selected AD sets for different positioning techniques (e.g., RTT, RSTD, OTDOA, DL-TDOA, etc.). The selected AD set(s) message 826 may indicate whether a respective AD set is for DL PRS transfer or UL PRS transfer. The TRP 300 transmits a selected AD set(s) message 827 to the UE 500 indicating the selected AD set(s) indicated by the selected AD set(s) message 826.

At stage 830, if the UE 500 is configured to support SL PRS, and the UE 500 selected one or more SL AD sets and/or received an indication of one or more selected SL AD sets, then the UE 500 may transmit an SL PRS enable message 831 to the UE 801 and/or transmit an SL AD set(s) message 832 to the TRP 300. The SL PRS enable message 831 may be sent to multiple anchor UEs (UEs whose locations are known) for mode 2 SL PRS transfer (i.e., SL PRS transfer without coordination by the TRP 300). The SL PRS enable message 831 may indicate to the UE 801 whether to enable SL PRS. The SL AD set(s) message 832 may indicate, for mode 2 SL PRS transfer (i.e., SL PRS transfer coordinated by the TRP 300), to the TRP 300 the selected Uu AD set(s) (e.g., DL AD set(s) and/or UL AD set(s)) and the selected SL AD set(s) selected at sub-stage 822 and/or sub-stage 825.

At stage 840, PRS are transferred between the UE 500 and the TRP 300 and/or between the UE 500 and the UE 801. The PRS are transferred in accordance with the selected AD set(s), e.g., selected at sub-stage 822 or sub-stage 825. If SL positioning is being implemented, the UE 500 transmits PRS 841 to the UE 801 in accordance with the selected SL AD set(s) and/or the UE 801 transmits PRS 842 to the UE 500. In mode 1 operation, where PRS scheduling is coordinated by the server 600, the server 600 will select the SL AD set(s) for the UE 801 and the UE 500. In mode 2 operation, the UE 500 and the UE 801 coordinate to determine the AD set(s). The SL AD is independent of Uu AD. If Uu positioning is being implemented, the UE 500 transmits PRS 843 to the TRP 300 and/or the TRP 300 transmits PRS 844 to the UE 500. The receiving entity(ies) measure the respective PRS. The UE 801 may send measurement information regarding measurement of the PRS 841 to the UE 500. By transferring and measuring PRS in accordance with the selected AD set(s), positioning performance may be improved based on the criteria used to select the selected AD set(s), e.g., reducing latency and/or improving positioning accuracy.

At stage 850, the UE 500 may determine position information. For example, the UE 500 may determine PRS measurements, one or more ranges to one or more other entities (e.g., anchor UE(s), TRP(s)), and/or a position estimate for the UE 500. The UE 500 may transmit position information 851 to the server 600, with the position information 851 including some or all of the position information determined by the UE 500.

At stage 860, the TRP 300 may determine position information. For example, the TRP 300 may determine PRS measurements, a range to the UE 500, and/or a position estimate for the UE 500. The TRP 300 may transmit position information 861 to the server 600, with the position information 861 including some or all of the position information determined by the TRP 300.

At stage 870, the server 600 may determine position information. For example, the server 600 may use some or all of the position information 851, 861 to determine a position estimate for the UE 500.

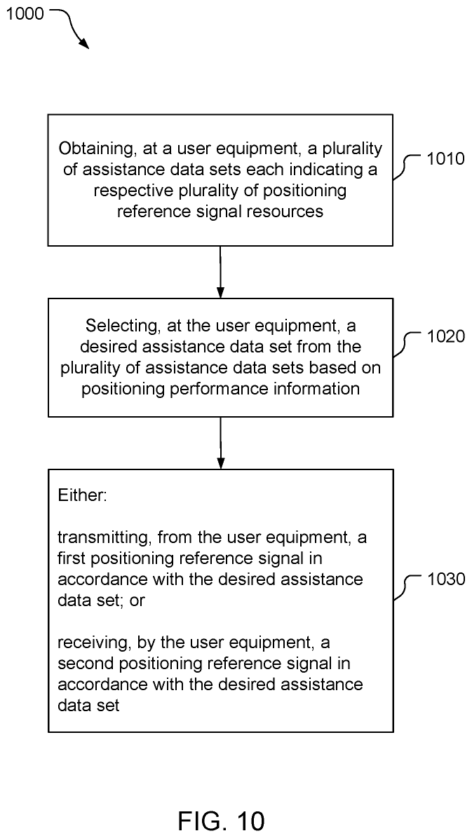

Referring to FIG. 10, with further reference to FIGS. 1-9, an assistance data selection and use method 1000 includes the stages shown. The method 1000 is, however, an example only and not limiting. The method 1000 may be altered, e.g., by having stages added, removed, rearranged, combined, performed concurrently, and/or having single stages split into multiple stages.

At stage 1010, the method 1000 includes obtaining, at a user equipment, a plurality of assistance data sets each indicating a respective plurality of positioning reference signal resources. For example, the UE 500 may receive one or more of the AD sets 812 and/or one or more of the AD sets 815 (for UL-PRS, DL-PRS, and/or SL-PRS), totaling two or more AD sets, with each of the AD sets 812, 815 indicating respective PRS resources. For example, the received AD sets may include the AD set 751 indicating PRS resources 1 through 64 of PRS resource set 1 of TRP 1 of PFL 1 shown in FIG. 7, and the AD set 752 indicating PRS resources 1 through 64 of PRS resource set 2 of TRP 1 of PFL 1 shown in FIG. 7. The processor 510, possibly in combination with the memory 530, in combination with the transceiver 520 (e.g., the wireless receiver 244 and the antenna 246) may comprise means for obtaining the plurality of assistance data sets. Also or alternatively, the processor 510 may retrieve AD sets (e.g., for SL PRS) from the memory 530, e.g., that were stored in the memory 530 during manufacture of the UE 500. The processor 510, in combination with the memory 530, (possibly in combination with the transceiver 520 if at least one of the assistance data sets are received from another entity) may comprise means for obtaining the plurality of assistance data sets.

At stage 1020, the method 1000 includes selecting, at the user equipment, a desired assistance data set from the plurality of assistance data sets based on positioning performance information. For example, the AD selection unit 550 may select one or more AD sets (depending upon whether the UE 500 is configured to support one AD set or more than one AD set), e.g., as discussed with respect to sub-stage 822, based on positioning performance information. The processor 510, possibly in combination with the memory 530, may comprise means for selecting the desired assistance data set.

At stage 1030, the method 1000 includes either: transmitting, from the user equipment, a first positioning reference signal in accordance with the desired assistance data set; or receiving, by the user equipment, a second positioning reference signal in accordance with the desired assistance data set. For example, at stage 840, the UE 500 may transmit the PRS 841 (SL-PRS) in accordance with the selected AD set(s) or may transmit the PRS 843 (UL-PRS) in accordance with the selected AD set(s). The processor 510, possibly in combination with the memory 530, in combination with the transceiver 520 (e.g., the wireless transmitter 242 and the antenna 246) may comprise means for transmitting the first PRS. As another example, at stage 840, the UE 500 may receive the PRS 844 (DL-PRS) in accordance with the selected AD set(s) or may receive the PRS 842 (SL-PRS) in accordance with the selected AD set(s). The processor 510, possibly in combination with the memory 530, in combination with the transceiver 520 (e.g., the wireless receiver 244 and the antenna 246) may comprise means for receiving the second PRS. Using the selected AD set(s) to measure or transmit PRS may help improve positioning performance. How the positioning performance is improved may depend on what information is used to select the AD set(s).

Implementations of the method 1000 may include one or more of the following features. In an example implementation, the positioning performance information comprises a latency threshold. For example, the AD selection unit 550 may select one or more AD sets based on a latency threshold for measuring and sending a PRS measurement report (e.g., in the position information 851). In a further example implementation, the positioning performance information comprises a plurality of measurement times each corresponding to an estimated amount of time for the user equipment to measure the respective plurality of positioning reference signal resources of a respective one of the plurality of assistance data sets. For example, the AD selection unit 550 may use measurement times (e.g., determined in accordance with Equations (1)-(5)) for multiple AD sets to select the one or more AD sets, e.g., to meet latency requirements. By using estimated measurement times to select the AD set(s), the latency may be reduced.

Also or alternatively, implementations of the method 1000 may include one or more of the following features. In an example implementation, the positioning performance information comprises a positioning accuracy. For example, the AD selection unit 550 may select the AD set(s) based on a position estimate accuracy and/or a PRS measurement accuracy corresponding to each of multiple available AD sets. By using estimated measurement accuracy to select the AD set(s), the positioning accuracy may be improved. In another example implementation, the positioning performance information comprises a plurality of positioning reference signal resource quantities each indicating a quantity of the respective plurality of positioning reference signal resources of a respective one of the plurality of assistance data sets. For example, the AD selection unit 550 may select the AD set(s) based on the quantities of PRS resources in each of the selected AD set(s), e.g., (1) having at least a threshold quantity of PRS resources, (2) having the most PRS resources, (3) in reverse order of most to fewest PRS resources, a combination of (1) and (2), a combination of (2) and (3), or one or more other criteria. For example, the threshold quantity of PRS resources may be a quantity of PRS resources that will yield at least a threshold SNR (signal to noise ratio), e.g., of 7 dB, 10 dB, 15 dB, etc. In another example implementation, the user equipment is a first user equipment, and the positioning performance information comprises a quantity of second user equipments within range of the first user equipment. For example, the AD selection unit 550 may select the AD set(s) for Uu PRS based on there being fewer than a threshold quantity of other UEs within PRS range of the UE 500, especially if the SL-PRS AD set(s) have high periodicity (e.g., above a threshold periodicity such as 160 ms, 320 ms, 640 ms, or 1280 ms). In another example implementation, the user equipment is a first user equipment, and the positioning performance information comprises relative alignment between the respective plurality of positioning reference signal resources in each of the plurality of assistance data sets and ON times of a discontinuous reception pattern of a second user equipment within range of the first user equipment. For example, as discussed with respect to FIG. 9, the AD selection unit 550 may use the alignments of PRS resources in AD sets with DRX ON times of one or more other UEs to select AD set(s). By using alignment of PRS resource and DRX ON time to select the AD set(s), the latency and/or power consumption may be reduced. In another example implementation, the positioning performance information comprises a measurement gap configuration, a carrier-specific scaling factor, frequency range corresponding to each of the plurality of assistance data sets, an in-device co-existence consideration, or any combination of two or more thereof. For example, the AD selection unit 550 may use MG configuration and CSSF to select the AD set(s), or another combination of the listed information, or a single piece of the listed information. In another example implementation, selecting the desired assistance data set comprises selecting a plurality of desired assistance data sets from the plurality of assistance data sets based on the positioning performance information, and the assistance data selection and use method further comprises determining a priority order of the plurality of desired assistance data sets. For example, the AD selection unit 550 may select multiple AD sets based on the positioning performance information (e.g., that meet one or more criteria) and the AD selection unit 550 may prioritize the selected AD sets, e.g., based on at least some of the positioning performance information and/or based on other information. For example, the AD selection unit 550 may select multiple AD sets based on estimated measurement times for the selected AD sets being below a threshold measurement time, and may prioritize the selected AD sets based on the estimated measurement times and/or other information such as quantities of PRS resources in each of the selected AD sets. Using prioritized AD sets may improve latency and/or positioning accuracy (and/or other performance criteria depending on what information is used to prioritize the AD sets).

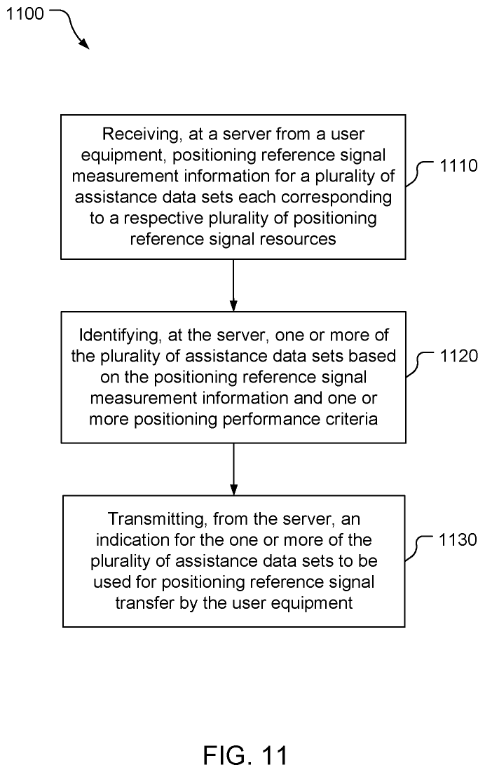

Referring to FIG. 11, with further reference to FIGS. 1-9, an assistance data indicating method 1100 includes the stages shown. The method 1100 is, however, an example only and not limiting. The method 1100 may be altered, e.g., by having stages added, removed, rearranged, combined, performed concurrently, and/or having single stages split into multiple stages.

At stage 1110, the method 1100 includes receiving, at a server from a user equipment, positioning reference signal measurement information for a plurality of assistance data sets each corresponding to a respective plurality of positioning reference signal resource. For example, the server 600 receives the measurement information message 824 from the UE 500 providing information for multiple AD sets. The processor 610, possibly in combination with the memory 630, in combination with the transceiver 620 (e.g., the wired receiver 454 and/or the wireless receiver 444 and the antenna 446) may comprise means for receiving PRS measurement information.

At stage 1120, the method 1100 includes identifying, at the server, one or more of the plurality of assistance data sets based on the positioning reference signal measurement information and one or more positioning performance criteria. For example, at sub-stage 825 the AD selection unit 650 may use the PRS measurement information and one or more positioning performance criteria (e.g., latency and/or positioning accuracy) to identify one or more AD sets for the UE 500 to use for PRS transfer (e.g., one or more AD sets for PRS reception (and measurement) and/or one or more AD sets for PRS transmission). The processor 610, possibly in combination with the memory 630, may comprise means for identifying one or more of the plurality of AD sets.

At stage 1130, the method 1100 includes transmitting, from the server, an indication for the one or more of the plurality of assistance data sets to be used for positioning reference signal transfer by the user equipment. For example, the server 600 transmits the selected AD set(s) message 826 indicating the one or more selected AD sets for the UE 500 to use for PRS transfer. The processor 610, possibly in combination with the memory 630, in combination with the transceiver 620 (e.g., the wired transmitter 452 and/or the wireless transmitter 442 and the antenna 446) may comprise means for transmitting the indication for the one or more of the plurality of AD sets to be used for PRS transfer by the UE.

Implementations of the method 1100 may include one or more of the following features. In an example implementation, the positioning reference signal measurement information comprises, for each of the plurality of assistance data sets: an estimated amount of time for the user equipment to measure the respective plurality of positioning reference signal resources; or one or more factors based on which the estimated amount of time depends; or a combination thereof; and the one or more positioning performance criteria comprise latency for determining a position estimate of the user equipment. For example, the AD selection unit 650 may use estimated measurement times (e.g., according to Equations (1)-(5)) and/or one or more factors affecting the estimated measurement times (e.g., CSSF) to select the AD set(s) to satisfy one or more latency requirements for determining a position estimate for the UE 500. In another example implementation, the positioning reference signal measurement information comprises, for each of the plurality of assistance data sets: an estimated positioning reference signal measurement accuracy; or one or more factors based on which the estimated positioning reference signal measurement accuracy depends; or a combination thereof; and the one or more positioning performance criteria comprise accuracy of a position estimate of the user equipment. For example, the AD selection unit 650 may use estimated measurement accuracies and/or one or more factors affecting the estimated measurement accuracies (e.g., quantities of PRS resources measured, bandwidth of PRS resources measured) to select the AD set(s) to satisfy one or more accuracy requirements for a position estimate for the UE 500. In another example implementation, identifying the one or more of the plurality of assistance data sets comprises: identifying one or more first assistance data sets of the plurality of assistance data sets for a first positioning technique; and identifying one or more second assistance data sets of the plurality of assistance data sets for a second positioning technique that is different from the first positioning technique. In this example implementation, the indication is a first indication for the one or more first assistance data sets to be used for positioning reference signal transfer by the user equipment for the first positioning technique, and the assistance data indicating method further comprises transmitting, from the server, a second indication for the one or more second assistance data sets to be used for positioning reference signal transfer by the user equipment for the second positioning technique. For example, the AD selection unit 650 may identify one or more AD sets for each of different positioning techniques (e.g., RSTD, RTT, OTDOA, etc.), and the selected AD set(s) message 826 may indicate the selected AD set(s) for each of the positioning techniques.

### Implementation Examples

Implementation examples are provided in the following numbered clauses.

Clause 1. A user equipment comprising:
a transceiver;
a memory; and
a processor, communicatively coupled to the memory and the transceiver, configured to:
   obtain a plurality of assistance data sets each indicating a respective plurality of positioning reference signal resources; and
   select a desired assistance data set from the plurality of assistance data sets based on positioning performance information;
   wherein the processor is:
      configured to transmit, via the transceiver, a first positioning reference signal in accordance with the desired assistance data set; or
      configured to receive, via the transceiver, a second positioning reference signal in accordance with the desired assistance data set; or
      a combination thereof.

Clause 2. The user equipment of clause 1, wherein the positioning performance information comprises a latency threshold.

Clause 3. The user equipment of clause 2, wherein the positioning performance information comprises a plurality of measurement times each corresponding to an estimated amount of time for the user equipment to measure the respective plurality of positioning reference signal resources of a respective one of the plurality of assistance data sets.

Clause 4. The user equipment of clause 1, wherein the positioning performance information comprises a positioning accuracy.

Clause 5. The user equipment of clause 1, wherein the processor is further configured to transmit, via the transceiver to a network entity, a capability message indicating independent capabilities of the user equipment to process and store assistance data, and wherein to obtain the plurality of assistance data sets, the processor is configured to receive the plurality of assistance data sets via the transceiver from the network entity in response to the capability message.

Clause 6. The user equipment of clause 1, wherein the positioning performance information comprises a plurality of positioning reference signal resource quantities each indicating a quantity of the respective plurality of positioning reference signal resources of a respective one of the plurality of assistance data sets.

Clause 7. The user equipment of clause 1, wherein the user equipment is a first user equipment, and wherein the positioning performance information comprises a quantity of second user equipments within range of the first user equipment.

Clause 8. The user equipment of clause 1, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

Clause 9. The user equipment of clause 1, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

Clause 10. The user equipment of clause 1, wherein the processor is configured to select a plurality of desired assistance data sets from the plurality of assistance data sets based on the positioning performance information and to determine a priority order of the plurality of desired assistance data sets.

Clause 11. An assistance data selection and use method comprising:
obtaining, at a user equipment, a plurality of assistance data sets each indicating a respective plurality of positioning reference signal resources;
selecting, at the user equipment, a desired assistance data set from the plurality of assistance data sets based on positioning performance information; and
either:
   transmitting, from the user equipment, a first positioning reference signal in accordance with the desired assistance data set; or
   receiving, by the user equipment, a second positioning reference signal in accordance with the desired assistance data set.

Clause 12. The assistance data selection and use method of clause 11, wherein the positioning performance information comprises a latency threshold.

Clause 13. The assistance data selection and use method of clause 12, wherein the positioning performance information comprises a plurality of measurement times each corresponding to an estimated amount of time for the user equipment to measure the respective plurality of positioning reference signal resources of a respective one of the plurality of assistance data sets.

Clause 14. The assistance data selection and use method of clause 11, wherein the positioning performance information comprises a positioning accuracy.

Clause 15. The assistance data selection and use method of clause 11, further comprising transmitting, from the user equipment to a network entity, a capability message indicating independent capabilities of the user equipment to process and store assistance data, and wherein obtaining the plurality of assistance data sets comprises receiving the plurality of assistance data sets at the user equipment from the network entity in response to the capability message.

Clause 16. The assistance data selection and use method of clause 11, wherein the positioning performance information comprises a plurality of positioning reference signal resource quantities each indicating a quantity of the respective plurality of positioning reference signal resources of a respective one of the plurality of assistance data sets.

Clause 17. The assistance data selection and use method of clause 11, wherein the user equipment is a first user equipment, and wherein the positioning performance information comprises a quantity of second user equipments within range of the first user equipment.

Clause 18. The assistance data selection and use method of clause 11, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

Clause 19. The assistance data selection and use method of clause 11, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

Clause 20. The assistance data selection and use method of clause 11, wherein the selecting the desired assistance data set comprises selecting a plurality of desired assistance data sets from the plurality of assistance data sets based on the positioning performance information, the assistance data selection and use method further comprising determining a priority order of the plurality of desired assistance data sets.

Clause 21. A user equipment comprising:
means for obtaining a plurality of assistance data sets each indicating a respective plurality of positioning reference signal resources; and
means for selecting a desired assistance data set from the plurality of assistance data sets based on positioning performance information; and
further comprising:
   means for transmitting a first positioning reference signal in accordance with the desired assistance data set; or
   means for receiving a second positioning reference signal in accordance with the desired assistance data set; or
   a combination thereof.

Clause 22. The user equipment of clause 21, wherein the positioning performance information comprises a latency threshold.

Clause 23. The user equipment of clause 22, wherein the positioning performance information comprises a plurality of measurement times each corresponding to an estimated amount of time for the user equipment to measure the respective plurality of positioning reference signal resources of a respective one of the plurality of assistance data sets.

Clause 24. The user equipment of clause 21, wherein the positioning performance information comprises a positioning accuracy.

Clause 25. The user equipment of clause 21, further comprising means for transmitting, from the user equipment to a network entity, a capability message indicating independent capabilities of the user equipment to process and store assistance data, and wherein the means for obtaining the plurality of assistance data sets comprises means for receiving the plurality of assistance data sets from the network entity in response to the capability message.

Clause 26. The user equipment of clause 21, wherein the positioning performance information comprises a plurality of positioning reference signal resource quantities each indicating a quantity of the respective plurality of positioning reference signal resources of a respective one of the plurality of assistance data sets.

Clause 27. The user equipment of clause 21, wherein the user equipment is a first user equipment, and wherein the positioning performance information comprises a quantity of second user equipments within range of the first user equipment.

Clause 28. The user equipment of clause 21, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

Clause 29. The user equipment of clause 21, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

Clause 30. The user equipment of clause 21, wherein the means for selecting the desired assistance data set comprise means for selecting a plurality of desired assistance data sets from the plurality of assistance data sets based on the positioning performance information, and wherein the user equipment further comprises means for determining a priority order of the plurality of desired assistance data sets.

Clause 31. A non-transitory, processor-readable storage medium comprising processor-readable instructions to cause a processor of a user equipment to:
obtain a plurality of assistance data sets each indicating a respective plurality of positioning reference signal resources; and
select a desired assistance data set from the plurality of assistance data sets based on positioning performance information;
wherein the storage medium further comprises:
   processor-readable instructions to cause the processor to transmit a first positioning reference signal in accordance with the desired assistance data set; or
   processor-readable instructions to cause the processor to receive a second positioning reference signal in accordance with the desired assistance data set; or
   a combination thereof.

Clause 32. The non-transitory, processor-readable storage medium of clause 31, wherein the positioning performance information comprises a latency threshold.

Clause 33. The non-transitory, processor-readable storage medium of clause 32, wherein the positioning performance information comprises a plurality of measurement times each corresponding to an estimated amount of time for the user equipment to measure the respective plurality of positioning reference signal resources of a respective one of the plurality of assistance data sets.

Clause 34. The non-transitory, processor-readable storage medium of clause 31, wherein the positioning performance information comprises a positioning accuracy.

Clause 35. The non-transitory, processor-readable storage medium of clause 31, further comprising processor-readable instructions to cause the processor to transmit, to a network entity, a capability message indicating independent capabilities of the user equipment to process and store assistance data, and wherein the processor-readable instructions to cause the processor to obtain the plurality of assistance data sets comprise processor-readable instructions to cause the processor to receive the plurality of assistance data sets from the network entity in response to the capability message.

Clause 36. The non-transitory, processor-readable storage medium of clause 31, wherein the positioning performance information comprises a plurality of positioning reference signal resource quantities each indicating a quantity of the respective plurality of positioning reference signal resources of a respective one of the plurality of assistance data sets.

Clause 37. The non-transitory, processor-readable storage medium of clause 31, wherein the user equipment is a first user equipment, and wherein the positioning performance information comprises a quantity of second user equipments within range of the first user equipment.

Clause 38. The non-transitory, processor-readable storage medium of clause 31, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

Clause 39. The non-transitory, processor-readable storage medium of clause 31, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

Clause 40. The non-transitory, processor-readable storage medium of clause 31, wherein the processor-readable instructions to cause the processor to select the desired assistance data set comprise processor-readable instructions to cause the processor to select a plurality of desired assistance data sets from the plurality of assistance data sets based on the positioning performance information, and wherein the storage medium further comprises processor-readable instructions to cause the processor to determine a priority order of the plurality of desired assistance data sets.

Clause 41. A server comprising:
a transceiver;
a memory; and
a processor, communicatively coupled to the memory and the transceiver, configured to:
   receive, via the transceiver from a user equipment, positioning reference signal measurement information for a plurality of assistance data sets each corresponding to a respective plurality of positioning reference signal resources;
   identify one or more of the plurality of assistance data sets based on the positioning reference signal measurement information and one or more positioning performance criteria; and
   transmit, via the transceiver, an indication for the one or more of the plurality of assistance data sets to be used for positioning reference signal transfer by the user equipment.

Clause 42. The server of clause 41, wherein:
the positioning reference signal measurement information comprises, for each of the plurality of assistance data sets:
   an estimated amount of time for the user equipment to measure the respective plurality of positioning reference signal resources; or
   one or more factors based on which the estimated amount of time depends; or
   a combination thereof; and
the one or more positioning performance criteria comprise latency for determining a position estimate of the user equipment.

Clause 43. The server of clause 41, wherein:
the positioning reference signal measurement information comprises, for each of the plurality of assistance data sets:
   an estimated positioning reference signal measurement accuracy; or
   one or more factors based on which the estimated positioning reference signal measurement accuracy depends; or
   a combination thereof; and
the one or more positioning performance criteria comprise accuracy of a position estimate of the user equipment.

Clause 44. The server of clause 41, wherein the processor is configured to identify one or more first assistance data sets of the plurality of assistance data sets for a first positioning technique, to identify one or more second assistance data sets of the plurality of assistance data sets for a second positioning technique that is different from the first positioning technique, wherein the indication is a first indication for the one or more first assistance data sets to be used for positioning reference signal transfer by the user equipment for the first positioning technique, and wherein the processor is configured to transmit, via the transceiver, a second indication for the one or more second assistance data sets to be used for positioning reference signal transfer by the user equipment for the second positioning technique.

Clause 45. An assistance data indicating method comprising:
receiving, at a server from a user equipment, positioning reference signal measurement information for a plurality of assistance data sets each corresponding to a respective plurality of positioning reference signal resources;
identifying, at the server, one or more of the plurality of assistance data sets based on the positioning reference signal measurement information and one or more positioning performance criteria; and
transmitting, from the server, an indication for the one or more of the plurality of assistance data sets to be used for positioning reference signal transfer by the user equipment.

Clause 46. The assistance data indicating method of clause 45, wherein:
the positioning reference signal measurement information comprises, for each of the plurality of assistance data sets:
   an estimated amount of time for the user equipment to measure the respective plurality of positioning reference signal resources; or
   one or more factors based on which the estimated amount of time depends; or
   a combination thereof; and
the one or more positioning performance criteria comprise latency for determining a position estimate of the user equipment.

Clause 47. The assistance data indicating method of clause 45, wherein:
the positioning reference signal measurement information comprises, for each of the plurality of assistance data sets:
   an estimated positioning reference signal measurement accuracy; or
   one or more factors based on which the estimated positioning reference signal measurement accuracy depends; or
   a combination thereof; and
the one or more positioning performance criteria comprise accuracy of a position estimate of the user equipment.

Clause 48. The assistance data indicating method of clause 45, wherein:
identifying the one or more of the plurality of assistance data sets comprises:
   identifying one or more first assistance data sets of the plurality of assistance data sets for a first positioning technique; and
   identifying one or more second assistance data sets of the plurality of assistance data sets for a second positioning technique that is different from the first positioning technique;
the indication is a first indication for the one or more first assistance data sets to be used for positioning reference signal transfer by the user equipment for the first positioning technique; and
the assistance data indicating method further comprises transmitting, from the server, a second indication for the one or more second assistance data sets to be used for positioning reference signal transfer by the user equipment for the second positioning technique.

Clause 49. A server comprising:
means for receiving, from a user equipment, positioning reference signal measurement information for a plurality of assistance data sets each corresponding to a respective plurality of positioning reference signal resources;
means for identifying one or more of the plurality of assistance data sets based on the positioning reference signal measurement information and one or more positioning performance criteria; and
means for transmitting an indication for the one or more of the plurality of assistance data sets to be used for positioning reference signal transfer by the user equipment.

Clause 50. The server of clause 49, wherein:
the positioning reference signal measurement information comprises, for each of the plurality of assistance data sets:
   an estimated amount of time for the user equipment to measure the respective plurality of positioning reference signal resources; or
   one or more factors based on which the estimated amount of time depends; or
   a combination thereof; and
the one or more positioning performance criteria comprise latency for determining a position estimate of the user equipment.

Clause 51. The server of clause 49, wherein:
the positioning reference signal measurement information comprises, for each of the plurality of assistance data sets:
   an estimated positioning reference signal measurement accuracy; or
   one or more factors based on which the estimated positioning reference signal measurement accuracy depends; or
   a combination thereof; and
the one or more positioning performance criteria comprise accuracy of a position estimate of the user equipment.

Clause 52. The server of clause 49, wherein:
the means for identifying the one or more of the plurality of assistance data sets comprises:
   means for identifying one or more first assistance data sets of the plurality of assistance data sets for a first positioning technique; and
   means for identifying one or more second assistance data sets of the plurality of assistance data sets for a second positioning technique that is different from the first positioning technique;
the indication is a first indication for the one or more first assistance data sets to be used for positioning reference signal transfer by the user equipment for the first positioning technique; and
the server further comprises means for transmitting a second indication for the one or more second assistance data sets to be used for positioning reference signal transfer by the user equipment for the second positioning technique.

Clause 53. A non-transitory, processor-readable storage medium comprising processor-readable instructions to cause a processor of a server to:
receive, from a user equipment, positioning reference signal measurement information for a plurality of assistance data sets each corresponding to a respective plurality of positioning reference signal resources;
identify one or more of the plurality of assistance data sets based on the positioning reference signal measurement information and one or more positioning performance criteria; and
transmit, from the server, an indication for the one or more of the plurality of assistance data sets to be used for positioning reference signal transfer by the user equipment.

Clause 54. The non-transitory, processor-readable storage medium of clause 53, wherein:
the positioning reference signal measurement information comprises, for each of the plurality of assistance data sets:
   an estimated amount of time for the user equipment to measure the respective plurality of positioning reference signal resources; or
   one or more factors based on which the estimated amount of time depends; or
   a combination thereof; and
the one or more positioning performance criteria comprise latency for determining a position estimate of the user equipment.

Clause 55. The non-transitory, processor-readable storage medium of clause 53, wherein:
the positioning reference signal measurement information comprises, for each of the plurality of assistance data sets:
   an estimated positioning reference signal measurement accuracy; or
   one or more factors based on which the estimated positioning reference signal measurement accuracy depends; or
   a combination thereof; and
the one or more positioning performance criteria comprise accuracy of a position estimate of the user equipment.

Clause 56. The non-transitory, processor-readable storage medium of clause 53, wherein:
the processor-readable instructions to cause the processor to identify the one or more of the plurality of assistance data sets comprise processor-readable instructions to cause the processor to:
   identify one or more first assistance data sets of the plurality of assistance data sets for a first positioning technique; and
   identify one or more second assistance data sets of the plurality of assistance data sets for a second positioning technique that is different from the first positioning technique;
the indication is a first indication for the one or more first assistance data sets to be used for positioning reference signal transfer by the user equipment for the first positioning technique; and
the storage medium further comprises processor-readable instructions to cause the processor to transmit a second indication for the one or more second assistance data sets to be used for positioning reference signal transfer by the user equipment for the second positioning technique.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
a transceiver;
a memory; and
a processor, communicatively coupled to the memory and the transceiver, configured to:
obtain a plurality of assistance data sets each indicating a respective plurality of positioning reference signal resources; and
select a desired assistance data set from the plurality of assistance data sets based on positioning performance information;
wherein the processor is:
configured to transmit, via the transceiver, a first positioning reference signal in accordance with the desired assistance data set; or
configured to receive, via the transceiver, a second positioning reference signal in accordance with the desired assistance data set; or
a combination thereof.

2. The user equipment of claim 1, wherein the positioning performance information comprises a latency threshold.

3. The user equipment of claim 2, wherein the positioning performance information comprises a plurality of measurement times each corresponding to an estimated amount of time for the user equipment to measure the respective plurality of positioning reference signal resources of a respective one of the plurality of assistance data sets.

4. The user equipment of claim 1, wherein the positioning performance information comprises a positioning accuracy.

5. The user equipment of claim 1, wherein the processor is further configured to transmit, via the transceiver to a network entity, a capability message indicating independent capabilities of the user equipment to process and store assistance data, and wherein to obtain the plurality of assistance data sets, the processor is configured to receive the plurality of assistance data sets via the transceiver from the network entity in response to the capability message.

6. The user equipment of claim 1, wherein the positioning performance information comprises a plurality of positioning reference signal resource quantities each indicating a quantity of the respective plurality of positioning reference signal resources of a respective one of the plurality of assistance data sets.

7. The user equipment of claim 1, wherein the user equipment is a first user equipment, and wherein the positioning performance information comprises a quantity of second user equipments within range of the first user equipment.

8. The user equipment of claim 1, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

9. The user equipment of claim 1, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

10. The user equipment of claim 1, wherein the processor is configured to select a plurality of desired assistance data sets from the plurality of assistance data sets based on the positioning performance information and to determine a priority order of the plurality of desired assistance data sets.

11. An assistance data selection and use method comprising:
obtaining, at a user equipment, a plurality of assistance data sets each indicating a respective plurality of positioning reference signal resources;
selecting, at the user equipment, a desired assistance data set from the plurality of assistance data sets based on positioning performance information; and
either:
transmitting, from the user equipment, a first positioning reference signal in accordance with the desired assistance data set; or
receiving, by the user equipment, a second positioning reference signal in accordance with the desired assistance data set.

12. The assistance data selection and use method of claim 11, wherein the positioning performance information comprises a latency threshold.

13. The assistance data selection and use method of claim 12, wherein the positioning performance information comprises a plurality of measurement times each corresponding to an estimated amount of time for the user equipment to measure the respective plurality of positioning reference signal resources of a respective one of the plurality of assistance data sets.

14. The assistance data selection and use method of claim 11, wherein the positioning performance information comprises a positioning accuracy.

15. The assistance data selection and use method of claim 11, further comprising transmitting, from the user equipment to a network entity, a capability message indicating independent capabilities of the user equipment to process and store assistance data, and wherein obtaining the plurality of assistance data sets comprises receiving the plurality of assistance data sets at the user equipment from the network entity in response to the capability message.

16. The assistance data selection and use method of claim 11, wherein the positioning performance information comprises a plurality of positioning reference signal resource quantities each indicating a quantity of the respective plurality of positioning reference signal resources of a respective one of the plurality of assistance data sets.

17. The assistance data selection and use method of claim 11, wherein the user equipment is a first user equipment, and wherein the positioning performance information comprises a quantity of second user equipments within range of the first user equipment.

18. The assistance data selection and use method of claim 11, wherein the user equipment is a first user equipment, and wherein the positioning performance information comprises relative alignment between the respective plurality of positioning reference signal resources in each of the plurality of assistance data sets and ON times of a discontinuous reception pattern of a second user equipment within range of the first user equipment.

19. The assistance data selection and use method of claim 11, wherein the positioning performance information comprises a measurement gap configuration, a carrier-specific scaling factor, frequency range corresponding to each of the plurality of assistance data sets, an in-device co-existence consideration, a multi-SIM (subscriber identity module) use consideration, an idle mode paging and measurement occasion collision consideration, or any combination of two or more thereof.

20. The assistance data selection and use method of claim 11, wherein the selecting the desired assistance data set comprises selecting a plurality of desired assistance data sets from the plurality of assistance data sets based on the positioning performance information, the assistance data selection and use method further comprising determining a priority order of the plurality of desired assistance data sets.

21. A server comprising:
a transceiver;
a memory; and
a processor, communicatively coupled to the memory and the transceiver, configured to:
receive, via the transceiver from a user equipment, positioning reference signal measurement information for a plurality of assistance data sets each corresponding to a respective plurality of positioning reference signal resources;
identify one or more of the plurality of assistance data sets based on the positioning reference signal measurement information and one or more positioning performance criteria; and
transmit, via the transceiver, an indication for the one or more of the plurality of assistance data sets to be used for positioning reference signal transfer by the user equipment.

22. The server of claim 21, wherein:
the positioning reference signal measurement information comprises, for each of the plurality of assistance data sets:
an estimated amount of time for the user equipment to measure the respective plurality of positioning reference signal resources; or
one or more factors based on which the estimated amount of time depends; or
a combination thereof; and
the one or more positioning performance criteria comprise latency for determining a position estimate of the user equipment.

23. The server of claim 21, wherein:
the positioning reference signal measurement information comprises, for each of the plurality of assistance data sets:
an estimated positioning reference signal measurement accuracy; or
one or more factors based on which the estimated positioning reference signal measurement accuracy depends; or
a combination thereof; and
the one or more positioning performance criteria comprise accuracy of a position estimate of the user equipment.

24. The server of claim 21, wherein the processor is configured to identify one or more first assistance data sets of the plurality of assistance data sets for a first positioning technique, to identify one or more second assistance data sets of the plurality of assistance data sets for a second positioning technique that is different from the first positioning technique, wherein the indication is a first indication for the one or more first assistance data sets to be used for positioning reference signal transfer by the user equipment for the first positioning technique, and wherein the processor is configured to transmit, via the transceiver, a second indication for the one or more second assistance data sets to be used for positioning reference signal transfer by the user equipment for the second positioning technique.

25. An assistance data indicating method comprising:
receiving, at a server from a user equipment, positioning reference signal measurement information for a plurality of assistance data sets each corresponding to a respective plurality of positioning reference signal resources;
identifying, at the server, one or more of the plurality of assistance data sets based on the positioning reference signal measurement information and one or more positioning performance criteria; and
transmitting, from the server, an indication for the one or more of the plurality of assistance data sets to be used for positioning reference signal transfer by the user equipment.

26. The assistance data indicating method of claim 25, wherein:
the positioning reference signal measurement information comprises, for each of the plurality of assistance data sets:
an estimated amount of time for the user equipment to measure the respective plurality of positioning reference signal resources; or
one or more factors based on which the estimated amount of time depends; or
a combination thereof; and
the one or more positioning performance criteria comprise latency for determining a position estimate of the user equipment.

27. The assistance data indicating method of claim 25, wherein:
the positioning reference signal measurement information comprises, for each of the plurality of assistance data sets:
an estimated positioning reference signal measurement accuracy; or
one or more factors based on which the estimated positioning reference signal measurement accuracy depends; or
a combination thereof; and
the one or more positioning performance criteria comprise accuracy of a position estimate of the user equipment.

28. The assistance data indicating method of claim 25, wherein:
identifying the one or more of the plurality of assistance data sets comprises:
identifying one or more first assistance data sets of the plurality of assistance data sets for a first positioning technique; and
identifying one or more second assistance data sets of the plurality of assistance data sets for a second positioning technique that is different from the first positioning technique;
the indication is a first indication for the one or more first assistance data sets to be used for positioning reference signal transfer by the user equipment for the first positioning technique; and
the assistance data indicating method further comprises transmitting, from the server, a second indication for the one or more second assistance data sets to be used for positioning reference signal transfer by the user equipment for the second positioning technique.
